(19) United States
(12) Patent Application Publication
(10) Pub. No.: US 2017/0307036 A1
(43) Pub. Date: Oct. 26, 2017

(54) BRAKE TELEMETRY SYSTEMS AND METHODS

(71) Applicant: GM GLOBAL TECHNOLOGY OPERATIONS LLC, Detroit, MI (US)

(72) Inventors: ANDREW M. NUESSER, WARREN, MI (US); JAMES A. WEBSTER, SHELBY TOWNSHIP, MI (US); STEVEN J. WEBER, MOUNT CLEMENS, MI (US); MARK T. RIEFE, BRIGHTON, MI (US); BRIAN S. PAPROCKI, MACOMB, MI (US); MICHAEL J. SHENBERGER, NOVI, MI (US)

(73) Assignee: GM GLOBAL TECHNOLOGY OPERATIONS LLC, Detroit, MI (US)

(21) Appl. No.: 15/133,696

(22) Filed: Apr. 20, 2016

(51) Int. Cl. F16D 66/02; F16D 66/00

(52) U.S. Cl. CPC F16D 66/021; F16D 66/00; F16D 2066/001

(57) ABSTRACT

Brake system telemetry systems and methods utilize wireless communication technology to communicate brake system data to one or more vehicle electronic control modules. A wireless transceiver is provided and is operably disposed with the brake system components. The wireless transceiver is coupled to receive data from various components of the brake system at the respective and to communicate the data to one or more electronic control units within the vehicle.

### TECHNICAL FIELD

This invention generally relates to telemetry systems of a vehicle, and more particularly, this invention relates to wireless telemetry systems and methods for vehicle brake systems.

### BACKGROUND

Brake systems for road vehicles are designed to operate at a high level of performance and reliability. Accurate information regarding operating conditions of the brake systems components during use is therefore desired to optimize and maintain brake system performance and to advise the vehicle operator of brake system service needs. However, reliably obtaining data from wheel-borne brake system components such as calipers, brake linings (e.g., brake pads), rotors and the like requires routing wire harnesses to these components at each wheel. Owing to the movement of the wheel during vehicle use and the potentially harsh environment at each wheel, providing wiring to each wheel to monitor brake system components adds manufacturing cost and complexity and introduces potential reliability issues.

Optimization of vehicle and brake system operating conditions also requires accurate and timely system data. For example, to control brake component cooling requires real time brake system temperature information. Methods have been proposed to predict brake system temperatures based upon vehicle load; speed, deceleration rate and ambient temperatures. As will be appreciated, predictive algorithms are not actual brake component data, and thus have inherent inaccuracy. Additional algorithms have been proposed to predict brake system condition and maintenance needs as a result of use. These algorithms may provide acceptable indications, but they are not a substitute for actual data.

Accordingly, it is desirable to provide methods and systems to obtain and communicate brake system operating data, including brake system operating data from wheel-borne brake system components, without the addition of wiring harnesses. Furthermore, other desirable features and characteristics of the present invention will become apparent from the subsequent detailed description and the appended claims, taken in conjunction with the accompanying drawings and the foregoing technical field and background.

### SUMMARY

Brake system telemetry systems and methods utilize wireless communication technology to communicate brake system data to one or more vehicle electronic control modules. In one embodiment, a wireless transmitter is provided and is operably disposed with the brake system components located at each wheel of the vehicle. The wireless transmitter is coupled to receive data from various components of the brake system at the respective wheel and to wirelessly communicate the data to one or more electronic control units within the vehicle.

In another embodiment, a wireless transmitter is provided in connection with a brake system component sensors at each wheel of the vehicle. The wireless transmitter may part of a first module that measures and communicates brake system data. A second module, in response to the communicated brake system data, takes an action in connection with the operation of the vehicle or provides an indication of brake system condition to a user of the vehicle.

In another aspect of the herein described embodiments, the sensors and wireless transmitter at the wheel locations are characterized by an absence of wiring connections or harnesses to the sensors and/or wireless transmitter.

In still another embodiment, a method of monitoring brake system operation includes obtaining one or more brake system data, and wireless communicating the brake system operating data to a control module within the vehicle.

### DESCRIPTION OF THE DRAWINGS

The exemplary embodiments will hereinafter be described in conjunction with the following drawing figures, wherein like numerals denote like elements, and wherein:

FIG. 1 is a graphic depiction of a vehicle that includes a brake telemetry system in accordance with various embodiments;

FIG. 2 is a functional block diagram of a vehicle that includes a brake telemetry system in accordance with various embodiments; and

FIG. 3 is a schematic diagram of brake system components in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term system or module may refer to any combination or collection of mechanical and electrical hardware, software, firmware, electronic control component, processing logic, and/or processor device, individually or in any combination, including without limitation: application specific integrated circuit (ASIC), an electronic circuit, a processor (shared, dedicated, or group), memory that executes one or more software or firmware programs, a combinational logic circuit, and/or other suitable components that provide the described functionality.

Embodiments of the invention may be described herein in terms of functional and/or logical block components and various processing steps. It should be appreciated that such block components may be realized by any number, combination or collection of mechanical and electrical hardware, software, and/or firmware components configured to perform the specified functions. For example, an embodiment of the invention may employ various combinations of mechanical components, e.g., brake calipers, brake pads, brake lines and brake rotors; and electrical components, e.g., integrated circuit components, memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of mechanical and/or electronic systems, and that the vehicle systems described herein are merely exemplary embodiment of the invention.

For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

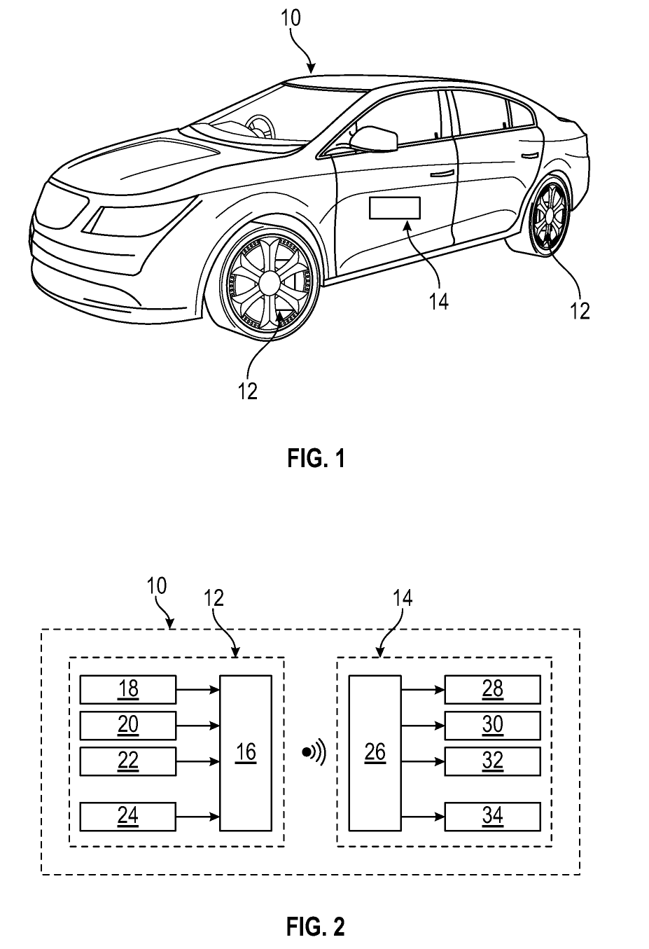

Referring now to FIGS. 1 and 2, a vehicle 10 is shown to include a first module including a vehicle brake telemetry system 12 and a second module including at least one electronic vehicle controller 14. For exemplary purposes, the disclosure will be discussed in the context of the brake telemetry system 12 reporting data from wheel locations of the vehicle 10. The skilled person will recognize that suitable components such as brake calipers, pads, rotors and lines may be disposed at each wheel of the vehicle 10, or that a centralized brake system may be envisioned wherein operative components are coupled to one or more driveline components in lieu of or in addition to components being disposed at the wheels. Additionally, it will be further appreciated that the herein described brake system components are joined to conventional vehicle operator actuation components, automated actuation components and various combinations thereof to affect on command brake application.

The brake telemetry system 12 couples a plurality of sensors to a wireless transmitter 16. The sensors and wireless transmitter 16 may be self-powered or self-powering, and operable absent any wire harness or wired connection thereto from other components or systems on or within the vehicle. As shown in FIG. 2, a plurality of data may be sensed, with four (4) data types shown for exemplary purposes. Exemplary data may include sensor provided brake rotor temperature 18, brake pad temperature 20, brake pressure 22 and pad wear 24. It will be appreciated that virtually any additional brake system operating parameter that may be observed, measured or sensed and reported as an electronic or digital value may be incorporated into the brake telemetry system 12.

Transmitter 16 is configured to communicate data via wireless transmission to a receiver 26 associated with vehicle controller 14. As depicted, the receiver 26 is a separate component within the vehicle controller 14. Alternatively, receiver 26 may be a separate component disposed within the vehicle 10 and communicatively linked to the electronic controller 14 and/or to other controllers within the vehicle 10 via, e.g., a communication bus. Vehicle controller 14 may additionally be communicatively linked to other controllers within the vehicle 10 and/or to communicate with or to control various systems within the vehicle 10, e.g., by a communication bus. As depicted in FIG. 2, the receiver 26 may communicate received data to a braking system controller 28, a body controller 30, a powertrain controller 32, a Driver Information Center (DIC) 34 or any other controller or module within the vehicle 10 that may benefit from or use the communicated data.

Transmitter 16 and receiver 26 may operate utilizing any suitable wireless communication protocol, and communication protocols for short range data communication within a vehicle are known. The transmitter 16 may be configured to prioritize data communication based upon data type. Data that may change rapidly with vehicle use may be reported with a first frequency, while data that changes slowly with vehicle use may be reported with a second frequency. For example, data relating to brake component temperature may be reported with a high frequency, while data relating to brake pad wear may be reported with a low frequency. Alternatively, an alarm or exception based protocol may be employed.

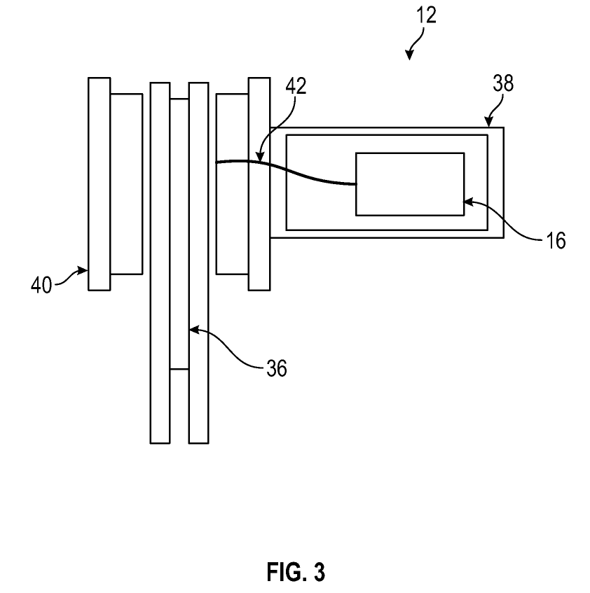

The schematic diagram of FIG. 3 illustrates the mechanical components of a vehicle brake system that may be disposed at each wheel of the vehicle, or may be coupled to a driveline component, such as a transmission, transfer case or differential output shaft. The brake system may include a brake rotor 36, a brake caliper 38, brake pads 40, all of which may be of conventional construction. The brake caliper 38 may be coupled conventionally via a hydraulic line to an operator or automated control to affect commanded brake action.

Transmitter 16 may be physically associated with the brake caliper 38 or other brake system component. Brake rotor 36/brake pads 40 may incorporate temperature and/or wear sensor 42, which may be an embedded wire loop or loops and/or thermo-couple type sensors within the brake pads 42. Other sensor technologies may be used. For example, an infra-red sensor may be used to measure brake rotor 36 or brake pad 40 temperature. As a further alternative, a printed sensor (not depicted) with multiple circuits may be embedded into the brake pads 40 to measure brake pad 40 temperature as a change in resistance in the circuit with change in temperature. Furthermore, there could be circuit loops at various depths in the brake pads 40 so that as the brake pads 40 wear, loops would wear through, opening that circuit, and denoting that the brake pad had worn through to that point.

The sensors and wireless transmitter 16 may include a battery power source. Alternatively, the sensors and wireless transmitter 16 may be self-powering by incorporating piezoelectric circuits that generate power from temperature changes and/or the motion and vibration during use of the vehicle 10. Other structures and methods to power the transmitter 16 without a direct wire connection power supply may be used.

Benefits from brake telemetry systems in accordance with herein described embodiments are readily apparent. Immediate, accurate information relating to the status and operation of brake system components can be known without the cost, complexity and reliability concerns of providing a wired connection to the wheel-borne brake system components. Service requirements, such as renewing brake friction materials, e.g., brake pads and brake rotors, can be readily and accurately determined. Conditions suggesting compromised braking performance are readily identified. In each case, timely and accurate information regarding the condition of the brake system can be made available to the vehicle operator through any number of means, including a Driver Information Center within the vehicle, and operation of the vehicle itself can be adjusted via various vehicle controllers.

Additional benefits and advantages can be derived from use of a brake telemetry system in accordance with the herein described embodiments in connection with the overall operation of the vehicle braking system and associated vehicle systems. It is known to incorporate air ducts within a vehicle to direct cooling air to the brake system components. Such air ducts introduce aerodynamic drag to the vehicle, which reduces vehicle economy or limits maximum vehicle performance. Accurate and timely information of brake system component temperatures allows active management of the air ducts via a body controller or brake system controller or combinations thereof, opening and closing the ducts as required to provide brake component cooling only when required.

Yet another advantage arises with the ability to diagnose brake system operation especially during autonomous vehicle operation and/or autonomous brake application events. Accurate and timely brake performance data provides necessary feedback to autonomous control systems ensuring correct brake system operation.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A brake telemetry system for a motor vehicle comprising:
a sensor associated with and operable to provide at least one data indicative of brake system operation; and
a wireless transmitter coupled to the sensor and wirelessly coupled with at least one control module of the vehicle and operable to wirelessly communicate the data from the sensor to the control module, wherein
the control module is configured to affect an action with respect to the operation of the vehicle responsive to the data.

2. The system of claim 1, the system characterized by the absence of a wired connection from the vehicle to the sensor and wireless transmitter.

3. (canceled)

4. The system of claim 1, the sensor and wireless transmitter being associated with and physically disposed with one of a brake caliper, a brake pad and a brake rotor.

5. (canceled)

6. (canceled)

7. The system of claim 1, the wireless transmitter being one of battery powered or self-powered.

8. (canceled)

9. (canceled)

10. (canceled)

11. A method of operating a vehicle responsive to a condition of a brake system operatively associated with the vehicle, the method comprising:
obtaining at least one brake system operation data;
wirelessly communicating the data to a control module of the vehicle; and affecting a change in operation of the vehicle responsive to the data.

12. (canceled)

13. The method of claim 11, wherein wirelessly communicating the data to a control module of the vehicle comprises physically associating a wireless transmitter with at least one of a brake caliper, a brake pad and a brake rotor.

14. The method of claim 13, wherein wirelessly communicating the data to a control module of the vehicle comprises self-powering the wireless transmitter.

15. A vehicle, comprising:
a brake telemetry system, the brake telemetry system including:
a sensor associated with and operable to provide at lease one data indicative of brake system operation; and
a wireless transmitter coupled to the sensor and wirelessly coupled with at least one control module of the vehicle and operable to wirelessly communicate the data from the sensor to the control module, wherein
the control module is configured to affect an action with respect to the operation of the vehicle responsive to the data .

16. The vehicle of claim 15, the sensor and wireless transmitter being associated with and physically disposed with one of a brake caliper, a brake pad and a brake rotor.

17. The vehicle of claim 15, wherein the sensor is one of a brake pad wear sensor and a temperature sensor.

18. (canceled)

19. The vehicle of claim 15, the system characterized by the absence of a wired connection from the vehicle to either the sensor or the wireless transmitter.

20. The system of claim 1, wherein the operation of the vehicle comprises an aerodynamic configuration of the vehicle.

21. The system of claim 20, wherein the aerodynamic configuration comprises brake component cooling.

22. The system of claim 1, wherein the operation of the vehicle comprises an autonomous operation.

23. The method of claim 11, wherein affecting a change in operation of the vehicle comprises changing an aerodynamic configuration of the vehicle.

24. The method of claim 11, wherein affecting a change in operation of the vehicle comprises increasing brake component cooling.

25. The method of claim 11, wherein affecting a change in operation of the vehicle comprises changing an autonomous operation of the vehicle.

26. The vehicle of claim 15, wherein the operation of the vehicle comprises an aerodynamic configuration of the vehicle.

27. The vehicle of claim 26, wherein the aerodynamic configuration comprises brake component cooling.

28. The vehicle of claim 15, wherein the operation of the vehicle comprises an autonomous operation.
